(19) United States
(12) Patent Application Publication
(10) Pub. No.: US 2023/0359932 A1
(43) Pub. Date: Nov. 9, 2023

(54) CLASSIFICATION PROCESS SYSTEMS AND METHODS

(71) Applicant: Rayyan Systems Inc., Cambridge, MA (US)

(72) Inventors: Robert Ayan, Watertown, MA (US); Hossam Hammady, Mississauga (CA)

(21) Appl. No.: 18/136,523

(22) Filed: Apr. 19, 2023

Related U.S. Application Data
(60) Provisional application No. 63/332,552, filed on Apr. 19, 2022.

(51) Int. Cl. G06N 20/00

(52) U.S. Cl. CPC G06N 20/00

(57) ABSTRACT

Presented herein are systems and methods for automated and/or semi-automated classification of research data via a collaboration platform, said platform designed for extraction and synthesis of research data from a collection (e.g., a disciplinary repository, such as an archive comprising research works, research articles, research data, etc. for any of a variety of research disciplines or subjects).

### CROSS-REFERENCE TO RELATED APPLICATIONS

This application claims priority to U.S. Provisional Application 63/332,552 filed on Apr. 19, 2022, the entirety of which is incorporated herein by reference.

### FIELD

This present invention relates generally to systems and methods for automated and/or semi-automated classification of research data.

### BACKGROUND

Whenever researchers define a new research topic or question, they want to search for all that is currently known about the defined topic or question to acquire knowledge, produce knowledge, or make evidence-based decisions. This process can be very time consuming, tedious and prone to error, fraud, and human biases. Without appropriate classification of research data (e.g., data and/or information elements) found in a search, the significance of the research data to the contexts, objectives, tasks, and/or workflows relevant to the new research topic or question may be indeterminate. Imprecise searching yields too much irrelevant information which must be further curated. Moreover, the finding of irrelevant information in an initial search does not mean that the initial search is sufficient to address the topic or question, as there still may be additional sources of data and information available that are relevant to the topic or question.

### SUMMARY

Presented herein are systems and methods for automated and/or semi-automated classification of research data via a collaboration platform, said platform designed for extraction and synthesis of research data from a collection (e.g., a disciplinary repository, such as an archive comprising research works, research articles, research data, etc. for any of a variety of research disciplines or subjects.) The classification enables identification of relevant research data, as well as the ability to refine or redefine the context of the research at hand (the question, search methods, protocol, objectives, workflow, and the like). In the latter case, for example, the discovery of “irrelevant” information in an early search may help redefine the scope of the research or question at hand, and/or the frequency of a term identified in the search results may refine the search methods.

In certain embodiments, an input comprising a classification context (e.g., a query or topic) is received, an input comprising a classification protocol (e.g., a user-defined configuration to facilitate review and feedback by a user of a set of outputs) is received, and an artificial intelligence (AI) module (e.g. a machine learning model, e.g. a natural language processing model, e.g. a neural network model) is executed in response to the classification context and in accordance with the classification protocol, to produce an output comprising research data. The output is then graphically or otherwise rendered for display or other presentation to a user via a display or presentation device, and a further input from the user comprising a classification action (e.g., acceptance or rejection by the user of a proposed search result) is received, where the classification action automatically recorded by the processor and/or used in further training the AI module.

For example, in one mode, a plurality of human reviewers provide feedback about a classification action. The feedback is used to train the AI model(s), but the AI model(s) may or may not be employed in the given mode to produce the classification action for which the human reviewers provide feedback. For example, there could be N number of reviewers who make classification decisions, and the protocol chosen will determine how many in agreement would render a classification decision correct. This acceptance would then train an AI model to learn from the decisions. This model could then be asked to render classification suggestions with a confidence level or rating. In certain embodiments, there is computer input only when asked and the computer input can either take the form of suggestions, recommendations, or auto-assignment of a classification with an indication that it was a machine generated suggestion or classification with a confidence level that is known. The confidence level threshold could be set to a minimum to allow a suggestion or recommendation to be accepted (e.g. 90%+).

In certain embodiments, the systems and methods facilitate human-computer collaboration to carry out research for greater speed, accuracy and simplicity. In certain embodiments, the methods and systems help a user curate data and/or information relevant to a user-defined topic or question through various means, for example, through search and curation of search results via automated or semi-automated classification. In some embodiments, the curated research data are initially unstructured, and relationships are drawn between and among the research data, including through customizations to produce classifications. This classification facilitates collaboration with a human user to further extract and synthesize the data via qualitative methods (e.g. any number of varieties of systematic review techniques, or other qualitative research) or quantitative methods (e.g. a meta-analysis).

More particularly, in certain embodiments, the systems and methods allow for automated and/or semi-automated, user-directed actions or activities conducted in a research workflow, for example to search, tag, annotate, reuse, identify, extract, synthesize, or combinations thereof, research data. In certain embodiments, the research data in their plurality, may include, for example, any type, form, or format. In certain embodiments, the research data in their plurality may include, for example, text, images, audio, video, code, papers, tables, databases, the output of a formula, the output of a function, the output of a process, or any other types of research data in any form, format, or symbolic representation. In certain embodiments, the research data are human readable, computer readable, or both. In some embodiments, the methods and systems comprise user defined protocols with acceptance criteria to provide for classification. This provides a more powerful search capability, relying on the combination of research data, user defined classifications, customizations, user defined protocols, user defined relationships, and/or combinations thereof.

The search process is improved by making conclusions about what is common about the identified and curated target data that contains useful information and by iterating on the search methods accordingly. The system, once trained using the training data from the classification process, can then apply itself to new sources of research data to help yield more relevant information.

In certain embodiments, the systems and methods presented herein are used by investigators conducting systematic literature reviews in the process of publishing scientific papers. In other embodiments, the systems and methods may be used to determine all that is known for a topic for medical research, or within a specific period of time to acquire the most recent information, for example the most recent research studies available within the past 5 years. For example, the systems and methods may be used to prepare for a clinical trial, to establish novelty, or to design health guidelines to treat patients. In certain other embodiments, the systems and methods may be used in the legal domains to find prior art, relevant case law, and e-discovery, for example, to find relevant documents in response to a subpoena. In some embodiments, the systems and methods may be used in finance to prioritize reading for deep dive research to see which competitor might ultimately prevail over another or to research SEC filings, for example. In some embodiments, the systems and methods may be used for any evidence-based decision making, for example public policy, human, social and economic development, industrial research, science and of course its major application in evidence-based medicine. In some embodiments, the systems and methods may be used by human resources personnel to review job applications, cover letters, resumes/curriculum vitae, letters of recommendation, and references. In some embodiments, the systems and methods may be used to identify subject matter experts. In some embodiments, the systems and methods may be used by a job applicant to identify relevant jobs. In some embodiments, the systems and methods may be used by a researcher to identify relevant grants.

In one aspect, the invention is directed to a method for automated and/or semi-automated classification of research data via a collaboration platform, said platform designed for extraction and synthesis of research data from a collection (e.g., a disciplinary repository, such as an archive comprising research works, research articles, research data, etc. for any of a variety of research disciplines or subjects), the method comprising: receiving, by a processor of a computing device, a first input comprising a classification context (e.g., wherein the classification context comprises a query or a topic); receiving, by the processor, a second input comprising a classification protocol (e.g., a user-defined configuration to facilitate review and feedback by a user of a set of outputs), wherein the classification protocol comprises one or more user-customizable features for obtaining and/or presenting output search results for review by a user [e.g., wherein the classification protocol comprises one or more members selected from the group consisting of: (i) instructions for determining the method for searching, (ii) requiring at least one classification action from at least one collaborator, (iii) establishing criteria to make, take, and/or perform at least one classification action, (iv) allowing or disallowing use of the artificial intelligence module, and (v) providing instructions on customizations]; executing an artificial intelligence (AI) module (e.g. a machine learning model, e.g. a natural language processing model, e.g. a neural network model) by the processor, in response to the classification context and, optionally, in accordance with a classification protocol, to produce an output comprising research data; and receiving, by the processor, a third input (e.g., from the user) comprising a plurality of classification actions (e.g., acceptance or rejection by the user of a proposed search result), the classification actions automatically recorded by the processor, wherein each of the plurality of classification actions is acceptance or rejection by the user of a proposed search result, and/or wherein the plurality of received classification actions is used in further training the AI module (e.g., wherein the thusly updated, trained AI module us used to produce further output search results of one or more subsequent user queries).

In certain embodiments, the method further comprises rendering (e.g., graphically rendering), by the processor, a presentation of the output to a user via a presentation device (e.g., via a display device).

In certain embodiments, the presentation of the output and/or the user-customizable settings is/are configurable by the user via at least one graphical user interface widget.

In certain embodiments, the at least one graphical user interface widget is a member selected from the group consisting of: a button (e.g., a radio button, e.g., a check box, e.g., a toggle switch, e.g., a toggle button, e.g., a split button, e.g., a cycle button), a slider, a list box, a spinner, a drop-down list, a menu (e.g., a context menu, e.g., a pie menu), a menu bar, a toolbar, a ribbon, an icon, a tree view, a grid view, a datagrid, a text box, and a combo box (e.g., a text box with attached menu or list box).

In certain embodiments, the presentation of the output is customizable by the user via the at least one graphical user interface (GUI) widget (e.g., said at least one GUI widget allowing selection of one or more output data presentation options selected from the group consisting of: (i) presenting both the Title and Abstract of search results (e.g., search results ordered based on relevance confidence level), (ii) the Title only, (iii) Full Texts, (iv) selection of a customized, user-defined configuration, and (v) creation of a new customized, user-defined configuration).

In certain embodiments, the user-customizable settings comprise one or more members selected from the group consisting of: (i) allowing a swipe gesture to include and exclude a search result, (ii) having swipe left include and swipe right to exclude, (iii) showing the include button on the right; showing an include/exclude button, (iv) showing an Abstract, (v) showing a Journal and Author information, (vi) showing Labels, (vii) showing Reasons for classification (viii) showing Decisions, and (ix) showing a “Maybe” designation indicating the classification of a given search result may not have sufficiently high confidence for automatic inclusion in the set of relevant search results.

In certain embodiments, the method comprises executing the artificial intelligence (AI) module (e.g. a machine learning model, e.g. a natural language processing model, e.g. a neural network model) by the processor, in response to the classification context and, optionally, in accordance with a classification protocol, to produce an output comprising research data beyond a scope of the classification context (e.g., outside the scope of the query or topic).

In certain embodiments, executing the AI module comprises searching a collection of research data for research data relevant to the classification context (the query or topic) in accordance with the classification protocol.

In certain embodiments, executing the AI module comprises labeling the research data identified as relevant with a code (e.g., and identifying a reason for excluding research data that are excluded as irrelevant, thereby supporting reproducibility and exclusion of duplicates).

In certain embodiments, the classification context comprises one or more strings of alphanumeric characters (e.g. natural language) and wherein the AI module comprises natural language processing (NLP) software.

In certain embodiments, the classification protocol comprises methods (e.g. techniques, strategies, logical systems) for searching for research data.

In certain embodiments, the classification action is user defined and comprises swiping, tapping, nodding, hot keys, buttons, mouse clicks, head movements, hand movements or gestures, voice recognition, brain activity, or any other user defined action or computer process associated with a customization action. In certain embodiments, the classification action is performed using an intermediary gadget that senses and interprets a user intention at the point of action.

In certain embodiments, the AI module produces the output and/or the processor renders the output in accordance with one or more user-defined customizations comprising one or more of the following: metadata, such as labels, reasons, notes, tags, types, sources, authors, definitions, categories, assessments; assigning relationships, ratings, rankings, scores, measures, grades, quality, probabilities, confidence; searching, selecting, sorting, filtering, categorizing, identifying, deleting, copying, extracting, archiving, filing, deciding, coding or curating; and any other user defined customizations in their plurality.

In certain embodiments, the AI module is trained using the received classification actions.

In certain embodiments, the steps are performed iteratively.

In certain embodiments, the classification context, the classification protocol, the output, or combinations thereof are published on a blockchain.

In certain embodiments, the method comprises providing for a compensatory exchange for publishing on the blockchain.

In another aspect, the invention is directed to a method for automated and/or semi-automated classification of research data via a collaboration platform, said platform designed for extraction and synthesis of research data from a collection (e.g., a disciplinary repository, such as an archive comprising research works, research articles, research data, etc. for any of a variety of research disciplines or subjects), the method comprising: receiving, by a processor of a computing device, a first input comprising a classification context, wherein the classification context comprises a query and/or a topic; receiving by the processor, a second input comprising a classification protocol, wherein the classification protocol comprises one or more user-customizable features for obtaining and/or presenting output search results for review by a user [e.g., wherein the classification protocol comprises one or more members selected from the group consisting of: (i) instructions for determining the method for searching, (ii) requiring at least one classification action from at least one collaborator, (iii) establishing criteria to make, take, and/or perform at least one classification action, (iv) allowing or disallowing use of the artificial intelligence module, and (v) providing instructions on customizations]; executing an artificial intelligence (AI) module (e.g. a machine learning model, e.g. a natural language processing model, e.g. a neural network model) by the processor, to produce the output search results in response to the classification context and in accordance with the classification protocol; graphically rendering, by the processor, a presentation of the output to the user via a presentation device (e.g., via a display device); and receiving, by the processor, a third input from comprising a plurality of classification actions (e.g., acceptance or rejection by the user of a proposed search result), the classification actions automatically recorded by the processor, wherein each of the plurality of classification actions is acceptance or rejection by the user of a proposed search result, and wherein the AI module is trained using the received plurality of classification actions (e.g., wherein the thusly updated, trained AI module is used to produce further output search results of one or more subsequent user queries); wherein (i) the presentation of the output and/or (ii) the user-customizable settings is/are configurable by the user via at least one graphical user interface widget.

In certain embodiments, the at least one graphical user interface widget is selected from one or more members of the group consisting of: a button (e.g., a radio button, e.g., a check box, e.g., a toggle switch, e.g., a toggle button, e.g., a split button, e.g., a cycle button), a slider, a list box, a spinner, a drop-down list, a menu (e.g., a context menu, e.g., a pie menu), a menu bar, a toolbar, a ribbon, an icon, a tree view, a grid view, a datagrid, a text box, and a combo box (e.g., a text box with attached menu or list box).

In certain embodiments, the presentation of the output comprises one or more members selected from the group consisting of: (i) presenting both the Title and Abstract of search results (e.g., search results ordered based on relevance confidence level), (ii) the Title only, (iii) Full Texts, (iv) selection of a customized, user-defined configuration, and (v) creation of a new customized, user-defined configuration.

In certain embodiments, the user-customizable settings comprise one or more members selected from the group consisting of: (i) allowing a swipe gesture to include and exclude a search result, (ii) having swipe left include and swipe right to exclude, (iii) showing the include button on the right; showing an include/exclude button, (iv) showing an Abstract, (v) showing a Journal and Author information, (vi) showing Labels, (vii) showing Reasons for classification (viii) showing Decisions, and (ix) showing a “Maybe” designation indicating the classification of a given search result may not have sufficiently high confidence for automatic inclusion in the set of relevant search results.

In another aspect, the invention is directed to a system for automated and/or semi-automated classification of research data (e.g., data and/or information elements) via a collaboration platform, said platform designed for extraction and synthesis of research data from a collection (e.g., a disciplinary repository, such as an archive comprising research works, research articles, research data, etc. for any of a variety of research disciplines or subjects), the system comprising: a processor of a computing device; and a memory having instructions stored thereon, wherein the instructions, when executed by the processor, cause the processor to perform any of the methods described herein.

### BRIEF DESCRIPTION OF THE DRAWING

The foregoing and other objects, aspects, features, and advantages of the present invention will become more apparent and better understood by referring to the following description taken in conjunction with the accompanying drawings, in which:

FIGS. 1A-1C are screenshots of a graphical user interface depicting an exemplary configuration for a user defined protocol, according to an illustrative embodiment.

FIG. 2A is a screenshot depicting an exemplary graphical display of an output received following input of a user defined context adhering to a user defined protocol, according to an illustrative embodiment.

FIGS. 2B-2G are a series of screenshots displaying the progression of a classification action being received, according to an illustrative embodiment.

FIG. 3 is a block flow diagram displaying a workflow of a collaboration platform, according to an illustrative embodiment.

FIG. 4 is a schematic showing an implementation of a network environment for use in providing systems, methods, and architectures as described herein, according to an illustrative embodiment.

FIG. 5 is a schematic showing exemplary computing devices that can be used to implement the techniques described, according to an illustrative embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

It is contemplated that systems, architectures, devices, methods, and processes of the claimed present invention encompass variations and adaptations developed using information from the embodiments described herein. Adaptation and/or modification of the systems, architectures, devices, methods, and processes described herein may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present invention that consist essentially of, or consist of, the recited components, and that there are processes and methods according to the present invention that consist essentially of, or consist of, the recited processing steps.

It should be understood that the order of steps or order for performing certain action is immaterial so long as the present invention remains operable. Moreover, two or more steps or actions may be conducted simultaneously.

The mention herein of any publication is not an admission that the publication serves as prior art with respect to any of the claims presented herein.

Documents are incorporated herein by reference as noted. Where there is any discrepancy in the meaning of a particular term, the meaning provided in this document is controlling.

Headers are provided for the convenience of the reader—the presence and/or placement of a header is not intended to limit the scope of the subject matter described herein.

Presented herein is a human-computer collaboration platform that provides capabilities that allow users to carry out actions or activities, such as but not limited to search, tag, annotate, reuse, identify, extract and synthesize research data. These include capabilities that humans or computers may possess independent of each other, or that neither humans nor computers possess alone, or that may be better accomplished through human-computer collaboration, which naturally creates an interdependency in order to complete user defined collaboration projects. These collaborations rely on user defined contexts, objectives and tasks in user defined workflows that adhere to a user defined protocol. The research data in their plurality may include any type, form or format, including text, images, audio, video, code, papers, tables, databases, the output of a formula, function or process, and any other types of data in any form format, or symbolic representation, whether human or computer readable, or both. The collaboration activities that the platform enables rely on user defined classification of the research data regardless of their type, form or format. Without a user defined classification of data, the significance of the data may be indeterminable relevant to the user defined contexts, objectives, tasks, or workflows, which are governed by user defined protocols to harmonize the actions taken by users and any computer enhanced or computer enabled involvement in the collaboration.

The process of classification involves taking actions which customize the data or information elements; in other words, the process of classification generates customizations. Customizations include, but are not limited to, applying metadata, such as labels, reasons, notes, tags, types, sources, authors, definitions, categories, assessments; assigning relationships, ratings, rankings, scores, measures, grades, quality, probabilities, confidence; searching, selecting, sorting, filtering, categorizing, identifying, deleting, copying, extracting, archiving, filing, deciding, coding or curating; and any other user defined customizations in their plurality. The customizations can be predefined prior to classification to provide a standard set, or defined during the collaboration, or a combination of both. Protocols, templates, classifications and search methods are examples of user defined classification methods that may be created, reused, shared, and exchanged by users.

Classification necessarily involves the application of user defined protocols; for example, determining the search methods, requiring a single or multiple human collaborators to make customizations, establishing user defined criteria to determine the correct classification, allowing or disallowing computer automation, or providing guidance for each or any of the defined customizations. As further example, a classification protocol might require that for a customization to be accepted, it will be by majority, by consensus or by unanimity, or by an expert or experts with the authority to determine the classification, or any other user defined protocol, that may necessarily include a defined process and set of criteria (e.g. a minimum #of customizations in agreement, the absence of conflicts, weighted average, minimum scoring, etc.). Classification includes binary and multiclass systems of classification, such as but not limited to relevant/irrelevant, include/exclude/maybe, low/medium/high, or any user defined system of classification. Classifications are defined in relation to user defined contexts, objectives, tasks, and workflows. Among classifications, the system may be used to identify relationships that may include, but not be limited to, contextual, hierarchical, relational, systemic, location-based, paired, class, domain, case, series, subject or instance based, causal, correlated, or other user defined relationships.

The system utilizes artificial intelligence technologies, including natural language processing, machine learning, facial and voice recognition, and image detection, among other technologies, to learn about the user defined contexts, objectives, tasks and workflows, and also learns from user actions to build models that can allow for semi and full automation of tasks. The system provides users with information that they may use to work through their data or information elements more efficiently or effectively. For example, after a sufficient number of classifications have been made, the system can then analyze all the research data to suggest further classifications and customizations in accordance with the objectives, tasks, and workflows consistent with the user defined protocol. The system may also highlight certain aspects of the data to draw the attention to the user, using visual cues like highlighting, filtering, sounds, or other methods, including user defined methods, and make it easy for the user to access the information based on the system of classification by filtering, sorting or ordering, or other user defined methods.

The method of action used to classify may be user defined to include such methods as swiping, tapping, nodding, tilting, eye movements, hot keys, buttons, mouse clicks, head movements, hand movements or gestures, voice recognition, brain activity, or any other user defined action or computer process associated with a customization action. The method of action to perform a customization may be via an intermediary gadget that senses and interprets a user intention at the point of action.

The system may operate in any number of modes of operation, including user guided, computer guided, manual, semi-automated, or fully automated, or any combination based on the user defined configurations. Configurations may be user defined, provided by the system, shared by other users, or dynamically generated by the system for the purposes of optimizing, maximizing or otherwise regulating and monitoring the collaboration for speed, quality, or other user defined objectives. Any trained AI models can remain in use indefinitely and can also be copied to or applied to new collaborations.

Operation may be user-guided—a user may work in either a manual, semi-automated, or fully-automated mode.

Operation may be computer guided—a user may be prompted to make decisions on system selected or prioritized items, which may consist of a random selection or based off of a user selection of attributes. This can be beneficial to rapidly training the system for optimal automated or machine assisted classification. The user can switch between user guided and computer guided modes of operations.

In manual operation—the user can work on a collaboration without additional computer assistance in a digitized workflow to perform classification.

In semi-automated operation, the user can work on a collaboration with computer assistance, using computer enhanced or computer enabled features, many of which rely on a plurality of artificial intelligence technologies, to provide heuristic cues such as highlighting keywords, recommending classifications, suggesting customizations, providing sorting, filtering, or workflow modifications, or other user configured semi-automation tasks or workflow modifications.

In fully automated operation, the system undertakes all classification tasks once it is sufficiently trained to undertake full automation.

Computer processes may use other data sources, such as information graphs, libraries, glossaries, directories, or other sources of data, in order to complete certain tasks. For example, the system may initiative a computer driven process for automated text mapping that relies on libraries of terms to act as a thesaurus to improve the search methods.

The system records each action taken by the user. It also features an option to write all customization data to the blockchain to create an immutable record of every action taken, which provides transparency to enable the ability to audit and reproduce the results. Users can be rewarded or compensated for their contributions to a collaboration. Contracts including smart contracts will be available to govern the ownership of the produced works or derivative works which may be minted as NFTs, and any of their data or information elements, and set the terms for the reward or compensation and any rights across a chain of custody in the case of sharing of these works or NFTs. The system will include a marketplace where data, services, code, apps, NFTs, and finished works may be exchanged for free, for a fee or for some other incentive or reward. The owner of the collaboration may elect to make the collaboration and any of its data or information elements public or private on the system and on the blockchain.

### Illustrative Example 1

A user defines a collaboration that will require identifying relevant information to extract and synthesize from a collection of research data, including literature that consists of published research studies and clinical trial data. The user defines the context in the form of a research topic or question, such as: “What is the effect of dexamethasone on pregnant women ages 18 to 35 who have early signs of the Omicron variant of COVID-19?” The defined context—in this case a clinical question that has become a research question—informs the user defined objectives, tasks, and workflows that will be performed by the collaborators. The question is based on several information elements, which include the set of research studies (e.g. systematic reviews, e.g. randomized trials, e.g. observational studies, etc.) which may or may not discuss the correct population group (pregnant women aged 18 to 35 with early signs of COVID-19) and clinical trial data, the specific intervention (the study of the use of the drug dexamethasone), or the defined objective of understanding the effect of the intervention on the population group. The objectives that address the context include identifying all of the relevant studies, eliminating all of the irrelevant studies, and extracting all of the relevant information. The tasks involve making customizations, including labeling all of the relevant studies in accordance with a system of coding, and providing reasons for any studies that will be excluded to support reproducibility, and deleting any duplicate references. The collaborators use devices, such as their mobile phones, tablets, laptops and desktops, to apply the common protocol communicated to all collaborators that will produce consistent results using any number of user defined methods to capture customizations such as head movements captured by the camera, directional swiping on a touch screen, voice recognition, tilting their device in specific ways to be recorded by a motion sensor, or any other method. The user defined protocol in this instance consists of at least two collaborators coming to agreement, although they will work independently of one another by being blinded to each other's customizations. The collaborators are able to train machine learning models, use features and functionality that are computer enabled or computer enhanced, in human guided, computer guided or human-computer guided modes. Once they are finished carrying out their assigned tasks, their customizations will be unblinded and examined for consistency, and any conflicts will be resolved by a third collaborator in accordance with this specific user defined protocol. The system can direct the conflicts automatically to the third collaborator depending on the configuration settings. These features and functionality may be manual, semi-automated, or fully automated. All of these user defined configurations can be set by the user independently or with saved settings, and the system may have default configuration settings or templates, or shared from other users across collaborations in a marketplace. The user can find collaborators in the marketplace, offer them incentives for their participation, and determine ownership and copyright over any of the works or derivative works produced. A published paper is produced as an NFT and distributed under the terms of a smart contract using blockchain technology. A data scientist was hired to join the collaboration using the marketplace, and he shares some code with the other users under the terms of their collaboration. The marketplace includes an escrow functionality to ensure the satisfaction of the parties with respect to the exchange of services and fees, if any. The authors decide to make the underlying data and code used “open” for use, and to provide for transparency, auditability, and reproducibility of their conclusions. One possible feature of a blockchain implementation is an “atomic transfer,” i.e., a simultaneous exchange of assets that eliminates the existence of escrow.

### Further Description

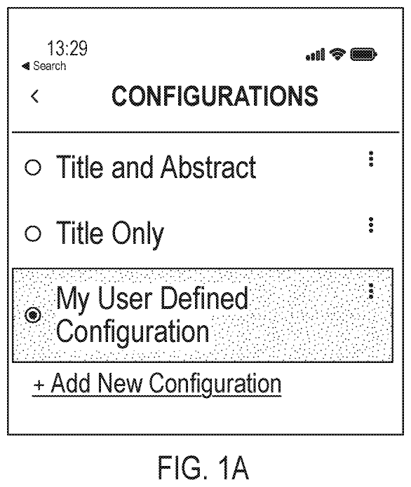

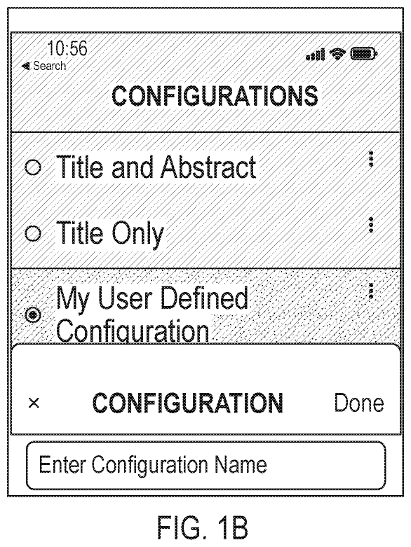

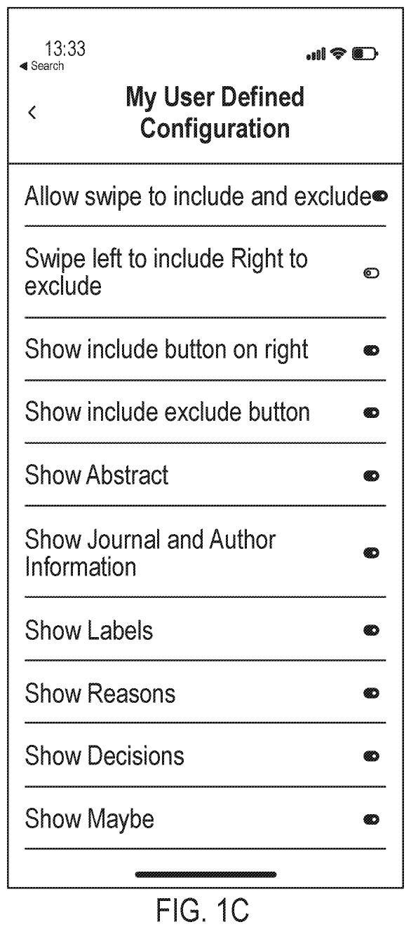

FIGS. 1A-1C are screenshots of a graphical user interface (GUI) depicting an exemplary configuration for a user defined search result classification protocol, according to an illustrative embodiment. In FIG. 1A, the GUI depicts radio buttons facilitating selection by the user of the options of graphical presentation of search result output—e.g., choice of presenting both the Title and Abstract of the search results (e.g., search results ordered based on relevance confidence level), the Title only, selection of a customized, user-defined configuration, or creation of a new customized, user-defined configuration. In FIG. 1B, the GUI depicts an entry widget with a space for the user to enter a configuration name. In FIG. 1C, the GUI depicts a variety of user-customizable settings/features (depicted as a series of toggles to turn on or off a given feature) for a user-defined configuration, e.g., allowing a swipe gesture to include and exclude a search result, having swipe left include and swipe right to exclude, showing the include button on the right, showing an include/exclude button, showing the Abstract, showing the Journal and Author information, showing Labels, showing Reasons (for classification), showing Decisions, showing a “Maybe” designation indicating the classification of a given search result may not have sufficiently high confidence for automatic inclusion in the set of relevant search results.

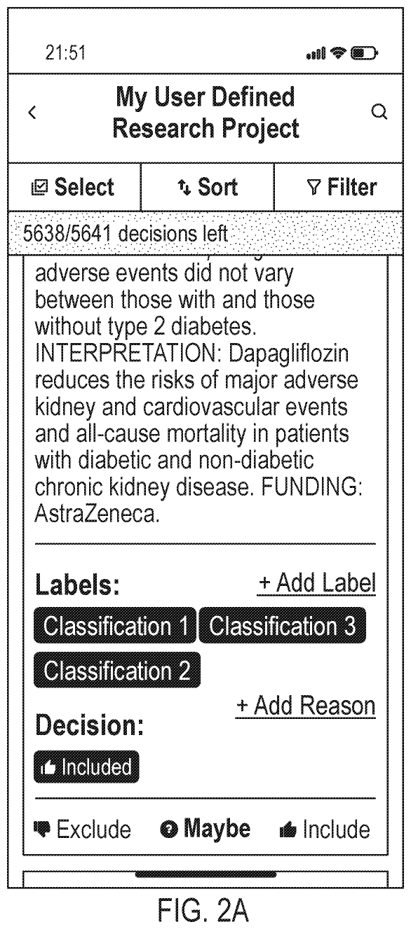

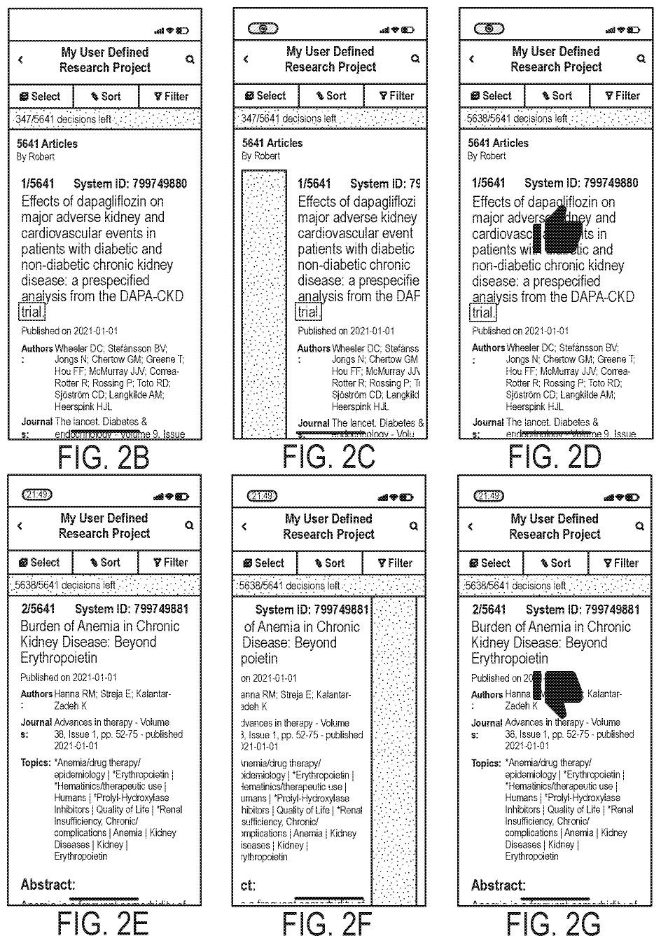

FIG. 2A is a screenshot depicting an exemplary graphical display of an output received following input of a user defined context adhering to a user defined protocol, according to an illustrative embodiment. In this example, the output includes a Title and Abstract, presented in the user defined research project. This particular output is item #5638 of 5641 outputs for which a relevance decision is queried. For each output, Labels may be automatically designed and/or selected by the user, and a Decision about relevance is presented, with the option to identify Reasons for the Decision. In this example, a “thumbs up” Decision to include the candidate output within the set of relevant outputs in the user defined research project.

FIGS. 2B-2G are a series of screenshots displaying the progression of a classification action being received, according to an illustrative embodiment. For example, FIGS. 2B and 2C show scrolling of a candidate search result by a user viewing the search result on a smart phone, followed by acceptance of the candidate search result as a relevant result in FIG. 2D, indicated by a green “thumbs up” symbol. Likewise, FIGS. 2E and 2F show scrolling of another candidate search result by a user, followed by exclusion of the search result in FIG. 2G, indicated by a red “thumbs down” symbol.

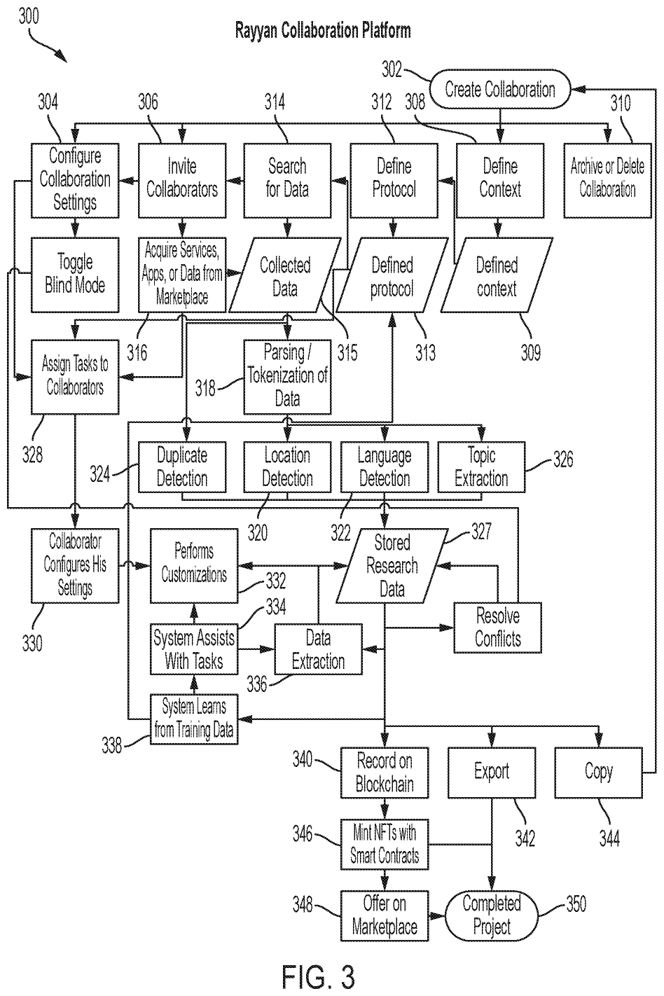

FIG. 3 is a block flow diagram displaying a workflow 300 of a collaboration platform, according to an illustrative embodiment. The blocks represent various steps and/or modules in a method and/or system for automated and/or semi-automated classification of research data via a collaboration platform. The topmost block indicates new creation of a collaboration 302. From here, collaboration settings are configured 304, collaborators are invited 306, a classification context (e.g., a query or topic) is defined 308, and/or the collaboration is archived or deleted 310. Once the context is defined, the protocol is defined 312 (e.g., a user-defined configuration to facilitate review and feedback by a user of a set of search outputs/results), then a search is conducted 314 for the defined context 309 in accordance with the defined protocol 313. Data is searched 314 and output data is collected 315. Following collaborator invitations 306, various services, apps, or data are acquired from the Marketplace 316 and used in processing the collected data 315. The collected data 315 is parsed/tokenized 318, and location 320, language 322, and duplicates 324 are detected. Topics are extracted 326, and output research data are stored 327. From the defined protocol 313, tasks are assigned to collaborators 328. Each collaborator configures his settings 330 and performs customizations 332 and provides feedback (e.g., acceptance or rejection of proposed/candidate search results). The system may assist with tasks 334, extract data 336, and/or learn from the training data 338. Results following collaborator feedback may be recorded on blockchain 340, exported 342, and/or copied 344. Results may be presented via a feedback loop to the collaboration, for example, for updated searches and/or processing of results. Non-fungible tokens (NFTs) may be minted with smart contracts 346, and/or offered on the Marketplace 348 prior to completion of the project 350.

Presented herein is a user configurable collaboration platform that allows for application of user-defined contexts, objectives, tasks and workflows according to a user defined protocol. For example, the platform enables human-computer collaboration for classification of research data regardless of their type, form or format. In some embodiments, classification of research data involves taking actions which lead to customization of research data. In some embodiments, classification of research data generates customizations of the research data. Customizations of research data may comprise metadata and/or applying metadata. In some embodiments metadata may comprise labels, reasons, notes, tags, types, sources, authors, definitions, categories, assessments; assigning relationships, ratings, rankings, scores, measures, grades, quality, probabilities, confidence; searching, selecting, sorting, filtering, categorizing, identifying, deleting, copying, extracting, archiving, filing, deciding, coding, curating, other customizations, or combinations thereof.

In some embodiments, the customizations can be predefined prior to classification, defined during classification, or both. Protocols, templates, classifications and search methods are examples of user defined classification methods that may be created, reused, shared, and exchanged by users.

In some embodiments, classification may comprise varying protocols. For example, varying protocols may comprise determining the search methods, requiring at least one classification action from at least one collaborator, establishing criteria to make, take, and/or perform the at least one classification action, allowing or disallowing use of a machine learning module, providing instructions on customizations, or combinations thereof.

In certain embodiments, a protocol might require majority, consensus, or unanimity of collaborators, wherein collaborators may comprise experts to determine classification and/or customization. In some embodiments, the protocol may include a set of criteria (e.g. a minimum #of customizations in agreement, the absence of conflicts, weighted average, minimum scoring, etc.) for classification and/or customization.

In some embodiments, classification may include binary and multiclass systems of classification. For example, binary and multiclass systems of classification may comprise, relevant/irrelevant, include/exclude/maybe, low/medium/high, or any varying system of classification. Classifications may be defined in relation to contexts, objectives, tasks, and workflows. In some embodiments, the present invention may identify relationships that may comprise contextual, hierarchical, relational, systemic, location-based, paired, class, domain, case, series, subject or instance based, causal, correlated, or other user defined relationships.

In certain embodiments, the present invention utilizes artificial intelligence (AI) which may comprise natural language process, machine learning, facial and voice recognition, and image detection, among other technologies, to learn about the contexts, objectives, tasks and workflows, and also learns from user actions to build models that can allow for semi and full automation of tasks.

In some embodiments, the present invention may provide for more efficient classification and/or customization of data and/or information element. For example, after a sufficient number of classifications have been made, the present invention may suggest further classifications and customizations in accordance with the objectives, tasks, and workflows consistent with the user defined protocol.

In certain embodiments, the present invention may emphasize certain aspects of the research data using sensory cues (e.g., visual feedback, auditory feedback, or tactile feedback) that may comprise highlighting, filtering, sounds, and/or other methods and make it easy for the user to access the information based on the system of classification by filtering, sorting or ordering, or other user defined methods.

In some embodiments, a classification action may comprise methods such as swiping, tapping, nodding, hot keys, buttons, mouse clicks, eye movements, head movements, hand movements or gestures, voice recognition, brain activity, or any other action or computer process. A classification action may be received via an intermediary gadget that senses and interprets a classification action at the point of action.

The present invention may operate in any number of modes of operation, including user guided, computer guided, manual, semi-automated, or fully automated, or any combination based on the user defined configurations. Such configurations may be user defined, provided by the system, shared by other users, or dynamically generated by the system for the purposes of optimizing, maximizing or otherwise regulating and monitoring the collaboration for speed, quality, or other user defined objectives. Any trained AI models can remain in use indefinitely and can also be copied to or applied to new collaborations. In some embodiments, user guided operation comprises a user working any way they like in either a manual, semi-automated, or fully automated mode. In some embodiments, computer guided operation comprises a user being prompted to take actions. In some embodiments, the prompts may occur randomly, or may occur due to certain configurations. This may provide for automated or assisted classification. In some embodiments, the user can switch between user guided and computer guided modes of operations. In some embodiments, manual operation may comprise no computer assistance during classification. In some embodiments, semi-automation operation may comprise computer assistance, computer-enhanced features, and/or computer-enabled features. In some embodiments, semi-automation may comprise machine learning/artificial intelligence (AI) modules. In some embodiments, AI may provide heuristic cues such as highlighting keywords, recommending classifications, suggesting customizations, providing sorting, filtering, or workflow modifications, other user configured semi-automation tasks, workflow modifications, or combinations thereof. In some embodiments, full automation may comprise the computer performing all classification tasks. In some embodiments, full automation occurs after the computer is trained to undertake full automation. In some embodiments, the present invention may use other data and/or information element sources, for example information graphs, libraries, directories, terms, or other sources of data. For example, the system may initiate a computer driven process for automated text mapping that relies on libraries of terms to act as a thesaurus to improve the search methods.

In some embodiments, every action taken by the user is recorded. In some embodiments, the present invention comprises classifications and/or customizations being written to a blockchain. In some embodiments, the present invention comprises exchange of compensation for contributions to a collaboration. For example, contracts (e.g. smart contracts) may be available. In some embodiments, collaborations, classifications, and/or customizations may be minted as NFTs, and any of their research data, and set the terms for the reward or compensation and any rights across a chain of custody in the case of sharing of these works or NFTs. In some embodiments, the present invention may comprise a marketplace where data, services, code, apps, NFTs, and finished collaborations may be exchanged for example, for free, for a fee, for some other incentive or reward, or combinations thereof. In some embodiments, the owner (e.g. a user, e.g. a creator, e.g. an author) of a collaboration may elect to make the collaboration and any of its research data public or private on the system and on the blockchain. In some embodiments, the present invention comprises each of these technologies individually or in combination with each other.

### Software, Computer System, and Network Environment

Certain embodiments described herein make use of computer algorithms in the form of software instructions executed by a computer processor. In certain embodiments, the software instructions include a machine learning module, also referred to herein as artificial intelligence software. As used herein, a machine learning module refers to a computer implemented process (e.g., a software function) that implements one or more specific machine learning techniques, e.g., artificial neural networks (ANNs), e.g., convolutional neural networks (CNNs), e.g., recursive neural networks, e.g., recurrent neural networks such as long short-term memory (LSTM) or Bilateral long short-term memory (Bi-LSTM), random forest, decision trees, support vector machines, and the like, in order to determine, for a given input, one or more output values. In certain embodiments, the input comprises alphanumeric data which can include numbers, words, phrases, or lengthier strings, for example. In certain embodiments, the one or more output values comprise values representing numeric values, words, phrases, chemical structures, symbols, or other alphanumeric strings.

For example, a machine learning/artificial intelligence (AI) module may receive as input a textual string (e.g., entered by a human user, for example) and generate various outputs. For example, the machine learning module may automatically analyze the input alphanumeric string(s) to determine output values classifying a content of the text (e.g., an intent), e.g., as in natural language understanding (NLU). In certain embodiments, a textual string is analyzed to generate and/or retrieve an output alphanumeric string. For example, a machine learning/artificial intelligence (AI) module may be (or include) any of a variety of language models (e.g., large language models, e.g., natural language processing models), which may be useful for natural language processing (NLP) software. Examples of language models which may be used in NLP software include, without limitation, Bidirectional Encoder Representations (BERT), Embeddings from Language Models (ELMo), BERT trained on clinical notes (ClinicalBERT), Distilled BERT (DistilBERT), Robustly Optimized BERT Approach (RoBERTa), A Light BERT (ALBERT), Decoding-enhanced BERT with Disentangled Attention (DeBERTa), Generalized Autoregressive Pretraining for Language Understanding (e.g., XLNet), Text-to-Text Transfer Transformer (T5), Generative Pre-Trained Transformer (GPT), Generative Pre-Trained Transformer 2 (GPT-2), Generative Pre-Trained Transformer 3 (GPT-3), and Generative Pre-Trained Transformer 4 (GPT-4), masked language models (MLM, e.g., ELECTRA), and Pathways Language Model (PaLM).

In certain embodiments, an AI module is used that performs a matching function similar to the profile matching function described in U.S. Pat. No. 9,733,811, “Matching process system and method,” the text of which is incorporated herein by reference in its entirety. However, in the present embodiments, the system and methods allow a user to determine a classification protocol (e.g., a user-defined configuration to facilitate review and feedback by the user of a set of outputs) and/or acceptance criteria.

In certain embodiments, machine learning modules implementing machine learning techniques are trained, for example using datasets that include categories of data described herein. Such training may be used to determine various parameters of machine learning algorithms implemented by a machine learning module, such as weights associated with layers in neural networks. In certain embodiments, once a machine learning module is trained, e.g., to accomplish a specific task such as identifying certain response strings, values of determined parameters are fixed and the (e.g., unchanging, static) machine learning module is used to process new data (e.g., different from the training data) and accomplish its trained task without further updates to its parameters (e.g., the machine learning module does not receive feedback and/or updates). In certain embodiments, machine learning modules may receive feedback, e.g., based on user review of accuracy, and such feedback may be used as additional training data, to dynamically update the machine learning module. In certain embodiments, two or more machine learning modules may be combined and implemented as a single module and/or a single software application. In certain embodiments, two or more machine learning modules may also be implemented separately, e.g., as separate software applications. A machine learning module may be software and/or hardware. For example, a machine learning module may be implemented entirely as software, or certain functions of a ANN module may be carried out via specialized hardware (e.g., via an application specific integrated circuit (ASIC)).

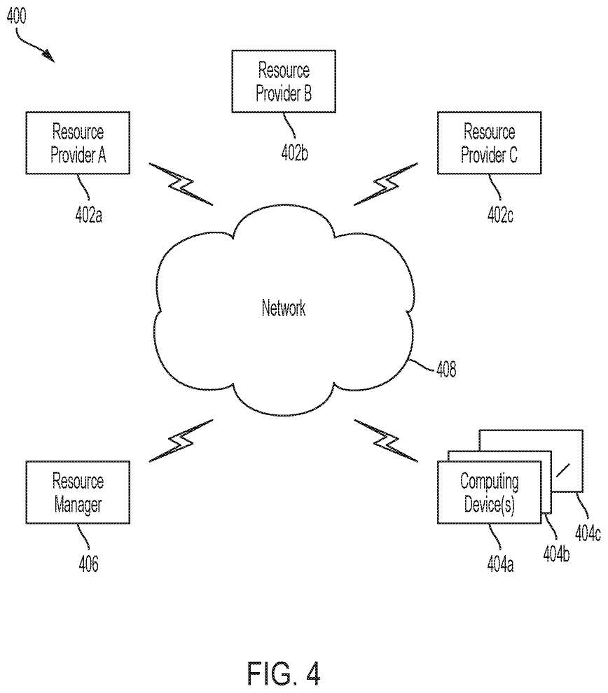

As shown in FIG. 4, an implementation of a network environment 400 for use in providing systems, methods, and architectures as described herein is shown and described. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

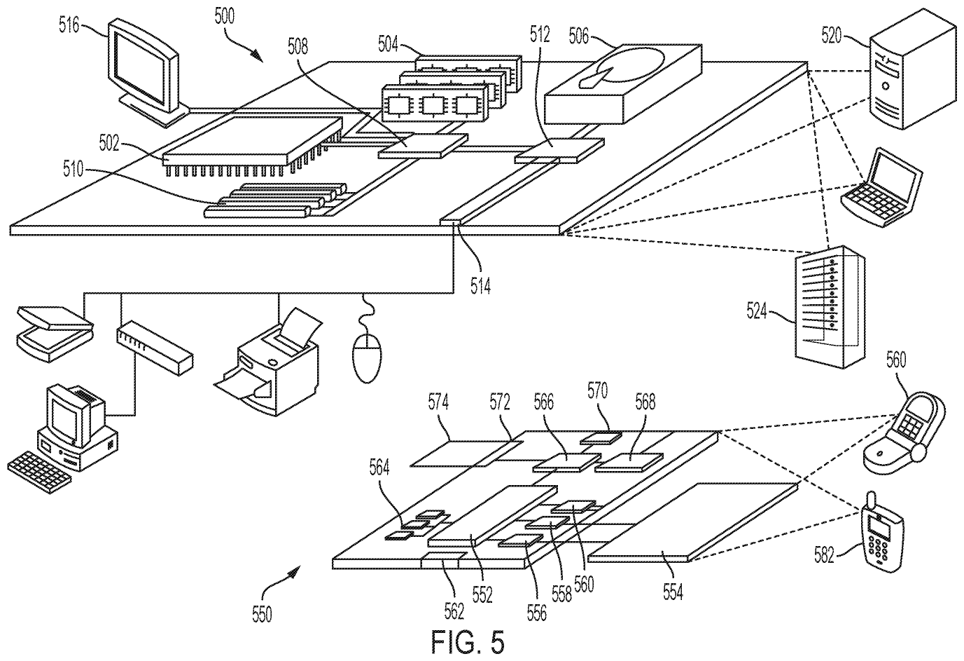

FIG. 5 shows an example of a computing device 500 and a mobile computing device 550 that can be used to implement the techniques described in this invention. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, certain modules described herein can be separated, combined or incorporated into single or combined modules. Any modules depicted in the figures are not intended to limit the systems described herein to the software architectures shown therein.

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein.

While the present invention has been particularly shown and described with reference to specific preferred embodiments, it should be understood by those skilled in the art that various changes in form and detail may be made therein without departing from the spirit and scope of the present invention as defined by the appended claims.

What is claimed is:

1. A method for automated and/or semi-automated classification of research data via a collaboration platform, said platform designed for extraction and synthesis of research data from a collection, the method comprising:
receiving, by a processor of a computing device, a first input comprising a classification context, wherein the classification context comprises a query and/or a topic;
receiving, by the processor, a second input comprising a classification protocol, wherein the classification protocol comprises one or more user-customizable features for obtaining and/or presenting output search results for review by a user;
executing an artificial intelligence (AI) module by the processor, to produce the output search results in response to the classification context and in accordance with the classification protocol; and
receiving, by the processor, a third input comprising a plurality of user classification actions, the classification actions automatically recorded by the processor, wherein each of the plurality of classification actions is acceptance or rejection by the user of a proposed search result, and wherein the AI module is trained using the received plurality of classification actions.

2. The method of claim 1, further comprising graphically rendering, by the processor, the output to the user via a presentation device.

3. The method of claim 2, wherein (i) the presentation of the output and/or (ii) the user-customizable settings is/are configurable by the user via at least one graphical user interface widget.

4. The method of claim 3, wherein the at least one graphical user interface widget is a member selected from the group consisting of: a button, a slider, a list box, a spinner, a drop-down list, a menu, a menu bar, a toolbar, a ribbon, an icon, a tree view, a grid view, a datagrid, a text box, and a combo box.

5. The method of claim 3, wherein the presentation of the output is customizable by the user via the at least one graphical user interface (GUI) widget.

6. The method of claim 3, wherein the user-customizable settings comprise one or more members selected from the group consisting of: (i) allowing a swipe gesture to include and exclude a search result, (ii) having swipe left include and swipe right to exclude, (iii) showing the include button on the right; showing an include/exclude button, (iv) showing an Abstract, (v) showing a Journal and Author information, (vi) showing Labels, (vii) showing Reasons for classification (viii) showing Decisions, and (ix) showing a “Maybe” designation indicating the classification of a given search result may not have sufficiently high confidence for automatic inclusion in the set of relevant search results.

7. The method of claim 1, comprising executing the artificial intelligence (AI) module by the processor, in response to the classification context and in accordance with the classification protocol, to produce an output comprising research data beyond a scope of the classification context.

8. The method of claim 1, wherein executing the AI module comprises searching a collection of research data for research data relevant to the classification context in accordance with the classification protocol.

9. The method of claim 1 wherein executing the AI module comprises labeling the research data identified as relevant with a code.

10. The method of claim 9 further comprising identifying a reason for excluding research data that are excluded as irrelevant, thereby supporting reproducibility and exclusion of duplicates.

11. The method of claim 1, wherein the classification context comprises one or more strings of alphanumeric characters and wherein the AI module comprises natural language processing (NLP) software.

12. The method of claim 1, wherein the classification action is user defined and comprises swiping, tapping, nodding, hot keys, buttons, mouse clicks, head movements, hand movements or gestures, voice recognition, brain activity, or any other user defined action or computer process associated with a customization action.

13. The method of claim 12, wherein the classification action is performed using an intermediary gadget that senses and interprets a user intention at the point of action.

14. The method of claim 1, wherein the AI module produces the output and/or the processor renders the output in accordance with one or more user-defined customizations comprising one or more of the following: metadata, such as labels, reasons, notes, tags, types, sources, authors, definitions, categories, assessments; assigning relationships, ratings, rankings, scores, measures, grades, quality, probabilities, confidence; searching, selecting, sorting, filtering, categorizing, identifying, deleting, copying, extracting, archiving, filing, deciding, coding or curating; and any other user defined customizations in their plurality.

15. The method of claim 1, where the AI module is trained using the received classification actions.

16. The method of claim 1, wherein the steps are performed iteratively.

17. The method of claim 1, wherein the classification context, the classification protocol, the output, or combinations thereof are published on a blockchain.

18. The method of claim 17, comprising providing for a compensatory exchange for publishing on the blockchain.

19. A system for automated and/or semi-automated classification of research data via a collaboration platform, said platform designed for extraction and synthesis of research data from a collection, the system comprising:
a processor of a computing device; and
a memory having instructions stored thereon, wherein the instructions, when executed by the processor, cause the processor to:
receive a first input comprising a classification context, wherein the classification context comprises a query and/or a topic;
receive a second input comprising a classification protocol, wherein the classification protocol comprises one or more user-customizable features for obtaining and/or presenting output search results for review by a user;
execute an artificial intelligence (AI) module to produce the output search results in response to the classification context and in accordance with a classification protocol; and
receive a third input from the user comprising a plurality of user classification actions, the classification actions automatically recorded by the processor, wherein each of the plurality of classification actions is acceptance or rejection by the user of a proposed search result, and wherein the AI module is trained using the received plurality of classification actions.

20. The system of claim 19, wherein the instructions, when executed by the processor, cause the processor to graphically render a presentation of the output to the user via a presentation device.

21. The system of claim 20, wherein (i) the presentation of the output and/or (ii) the user-customizable settings is/are configurable by the user via at least one graphical user interface widget.

22. The system of claim 21, wherein the at least one graphical user interface widget is a member selected from the group consisting of: a button, a slider, a list box, a spinner, a drop-down list, a menu, a menu bar, a toolbar, a ribbon, an icon, a tree view, a grid view, a datagrid, a text box, and a combo box.

23. The system of claim 21, wherein the presentation of the output is customizable by the user via the at least one graphical user interface (GUI) widget.

24. The system of claim 21, wherein the user-customizable settings comprise one or more members selected from the group consisting of: (i) allowing a swipe gesture to include and exclude a search result, (ii) having swipe left include and swipe right to exclude, (iii) showing the include button on the right; showing an include/exclude button, (iv) showing an Abstract, (v) showing a Journal and Author information, (vi) showing Labels, (vii) showing Reasons for classification (viii) showing Decisions, and (ix) showing a “Maybe” designation indicating the classification of a given search result may not have sufficiently high confidence for automatic inclusion in the set of relevant search results.

25. The system of claim 19, wherein the instructions, when executed by the processor, cause the processor to execute the artificial intelligence (AI) module in response to the classification context and in accordance with the classification protocol, to produce an output comprising research data beyond a scope of the classification context.

26. The system of claim 19, wherein executing the AI module comprises searching a collection of research data for research data relevant to the classification context in accordance with the classification protocol.

27. The system of claim 19, wherein executing the AI module comprises labeling the research data identified as relevant with a code.

28. The system of claim 27, wherein executing the AI module further comprises identifying a reason for excluding data and/or information elements that are excluded as irrelevant, thereby supporting reproducibility and exclusion of duplicates.

29. The system of claim 19, wherein the classification context comprises one or more strings of alphanumeric characters and wherein the AI module comprises natural language processing (NLP) software.

30. The system of claim 19, wherein the classification action is user defined and comprises swiping, tapping, nodding, hot keys, buttons, mouse clicks, head movements, hand movements or gestures, voice recognition, brain activity, or any other user defined action or computer process associated with a customization action.

31. The system of claim 30, wherein the classification action is performed using an intermediary gadget that senses and interprets a user intention at the point of action.

32. The system of claim 19, wherein the AI module produces the output and/or the processor renders the output in accordance with one or more user-defined customizations comprising one or more of the following: metadata, such as labels, reasons, notes, tags, types, sources, authors, definitions, categories, assessments; assigning relationships, ratings, rankings, scores, measures, grades, quality, probabilities, confidence; searching, selecting, sorting, filtering, categorizing, identifying, deleting, copying, extracting, archiving, filing, deciding, coding or curating; and any other user defined customizations in their plurality.

33. The system of claim 19, where the AI module is trained using the received classification actions.

34. The system of claim 19, wherein the processor performs steps iteratively.

35. The system of claim 19, wherein the classification context, the classification protocol, the output, or combinations thereof are published on a blockchain.

36. The system of claim 19, wherein the instructions, when executed by the processor, cause the processor to provide for a compensatory exchange for publishing on the blockchain.

37. A method for automated and/or semi-automated classification of research data via a collaboration platform, said platform designed for extraction and synthesis of research data from a collection, the method comprising:
receiving, by a processor of a computing device, a first input comprising a classification context, wherein the classification context comprises a query and/or a topic;
receiving by the processor, a second input comprising a classification protocol, wherein the classification protocol comprises one or more user-customizable features for obtaining and/or presenting output search results for review by a user;
executing an artificial intelligence (AI) module by the processor, to produce the output search results in response to the classification context and in accordance with the classification protocol;
graphically rendering, by the processor, a presentation of the output to the user via a presentation device; and
receiving, by the processor, a third input from comprising a plurality of classification actions, the classification actions automatically recorded by the processor, wherein each of the plurality of classification actions is acceptance or rejection by the user of a proposed search result, and wherein the AI module is trained using the received plurality of classification actions;
wherein (i) the presentation of the output and/or (ii) the user-customizable settings is/are configurable by the user via at least one graphical user interface widget.

38. The method of claim 37, wherein the at least one graphical user interface widget is selected from one or more members of the group consisting of: a button, a slider, a list box, a spinner, a drop-down list, a menu, a menu bar, a toolbar, a ribbon, an icon, a tree view, a grid view, a datagrid, a text box, and a combo box.

39. The method of claim 37, wherein the presentation of the output comprises one or more members selected from the group consisting of: (i) presenting both the Title and Abstract of search results, (ii) the Title only, (iii) Full Texts, (iv) selection of a customized, user-defined configuration, and (v) creation of a new customized, user-defined configuration.

40. The method of claim 37, wherein the user-customizable settings comprise one or more members selected from the group consisting of: (i) allowing a swipe gesture to include and exclude a search result, (ii) having swipe left include and swipe right to exclude, (iii) showing the include button on the right; showing an include/exclude button, (iv) showing an Abstract, (v) showing a Journal and Author information, (vi) showing Labels, (vii) showing Reasons for classification (viii) showing Decisions, and (ix) showing a “Maybe” designation indicating the classification of a given search result may not have sufficiently high confidence for automatic inclusion in the set of relevant search results.
